(19) United States
(12) Patent Application Publication
(10) Pub. No.: US 2025/0151713 A1
(43) Pub. Date: May 15, 2025

(54) Simulative Pond Device

(71) Applicant: Clifford West, Navasota, TX (US)

(72) Inventor: Clifford West, Navasota, TX (US)

(21) Appl. No.: 18/928,347

(22) Filed: Oct. 28, 2024

Related U.S. Application Data
(60) Provisional application No. 63/597,472, filed on Nov. 9, 2023.

(51) Int. Cl. A01M 31/06

(52) U.S. Cl. CPC A01M 31/06

(57) ABSTRACT

A simulative pond device is provided. The device is comprised of a lightweight base that is covered with a top surface that emulates water. This device can be accessorized with removable decorative elements such as faux ducks and lily pads to resemble a real lake or pond. The device is lightweight and foldable enabling hunters to attract wildlife in locations that are not near bodies of water.

### CROSS-REFERENCE TO RELATED APPLICATION

The present application claims priority to, and the benefit of, U.S. Provisional Application No. 63/597,472, which was filed on Nov. 9, 2023, and is incorporated herein by reference in its entirety.

### FIELD OF THE INVENTION

The present invention relates generally to the field of hunting equipment. More specifically, the present invention relates to a simulative pond device. This device is comprised of a base made from that simulates the appearance of water which can be accessorized with a decorative element that resembles wildlife and/or naturally occurring organic matter. Accordingly, the present disclosure makes specific reference thereto. Nonetheless, it is to be appreciated that aspects of the present invention are also equally applicable to other like applications, devices, and methods of manufacture.

### BACKGROUND

Many types of hunting involve attracting wildlife. This crucial aspect of hunting hinges on the hunter's ability to either accurately imitate or fully utilize the natural habitat of the game they are pursuing. For hunters targeting water-based game, the scenario presents unique challenges and opportunities. The natural habitat of these aquatic or semi-aquatic species typically includes various bodies of water, ranging from small ponds to large lakes and rivers. These water bodies serve as essential resources for the game, providing them with drinking water, food, and a place to breed and take refuge from predators. Therefore, a hunter seeking to attract water-based game must focus on replicating these aquatic environments or utilizing existing ones to lure the game into the open.

However, not all hunters have the luxury of easy access to such natural water bodies. The physical limitations of a hunter or the geographical absence of suitable water bodies can pose significant obstacles. Physical constraints may include mobility issues, health concerns, or the lack of necessary equipment to navigate or create artificial ponds. Similarly, the geographical absence of water implies that the hunter operates in a region where natural water bodies are scarce or entirely non-existent, further complicating the task of luring water-based game.

As a result, in situations where a pond or similar water body is not accessible, the hunter faces a severe disadvantage in their attempts to attract and hunt water-based game. This is because the absence of a critical element of the game's natural habitat severely diminishes the likelihood of successfully luring the target species.

Therefore, there exists a long-felt need in the art of hunting equipment for a device that eliminates the requirement of naturally occurring water to attract and hunt water-based wildlife. More specifically, there exists a long-felt need in the art of hunting for a simulative pond device that can be used to replicate naturally occurring bodies of water to attract water-based wildlife.

The subject matter disclosed and claimed herein, in one embodiment thereof, comprises a simulative pond device. The device is comprised of a base, the base can be secured to the ground by grommets and fasteners. The base preferably resembles the appearance of a pond with a water like top surface that can removable receive decorative objects that resemble water-based game. These decorative objects can be decoys including geese, ducks, and waterfowl.

In this manner, the simulative pond device of the present invention accomplishes all the forgoing objectives and provides a device that eliminates the requirement of naturally occurring water to attract water-based wildlife. Furthermore, the device can be used in any hunting environment that requires the attraction of water-based game.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a simulative pond device. The device is comprised of a base with a bottom surface, a top surface, at least one indicia, and at least one grommet. The device is designed such that the top surface of the base can receive at least one decorative element to simulate a pond and animals. The base is preferably any shape that resembles a body of water. The top surface has at least one indicia that may include but is not limited to patterns, textures, and shapes that replicate water, naturally occurring foliage, and other natural water scenery of the like. In one embodiment, the base is comprised of at least one grommet that allows at least one fastener to be driven through the grommet and into a ground surface to secure the base to said surface during use.

The device is also comprised of at least one decorative element comprised of a bottom surface comprised of at least one fastener. The fastener of the element removably attaches to at least one fastener of the top surface to allow the element to be repositioned or moved as needed. The decorative element may resemble plants and wildlife including but not limited to lily pads, grass, weeds, ducks, geese, swans, mallards and other such animals and wildlife found near any type of water. As a result, the device is able to replicate a naturally occurring habitat with water-based wildlife.

The present invention is also comprised of a method of using the device. First, a device is provided comprised of a base having a top surface comprised of at least one fastener and a decorative element comprised of at least one fastener located on a bottom surface of the decorative element. Then, the base can be secured to a ground surface by driving at least one fastener through at least one grommet of the base and into the ground surface. Next, at least one decorative element can be attached to the top surface of the base by attaching the fastener of the decorative element to the fastener of the top surface. Then, a user can position themselves near the device such that the device serves as a decoy to attract game birds while hunting for the same.

Accordingly, the simulative pond device of the present invention is particularly advantageous as it provides a device that eliminates the need for water while emulating the habitat of water-based game. More specifically, the simulative pond device can be used as an alternative for hunters that are physically constrained or have no access to water. Furthermore, the device is lightweight and can be universally used in any hunting environment. In this manner, the simulative pond device overcomes the limitations of existing hunting practices and devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a simulative pond device of the present invention in accordance with the disclosed architecture;

FIG. 2 illustrates an enhanced perspective view of a fastener and a grommet one potential embodiment of a simulative pond device of the present invention in accordance with the disclosed architecture;

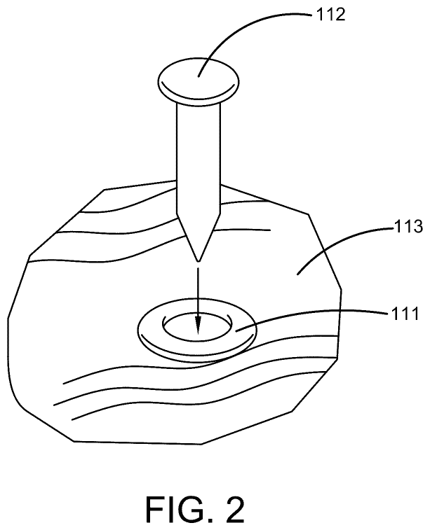

FIG. 3 illustrates an enhanced perspective view of a top surface and a decorative element one potential embodiment of a simulative pond device of the present invention in accordance with the disclosed architecture; and

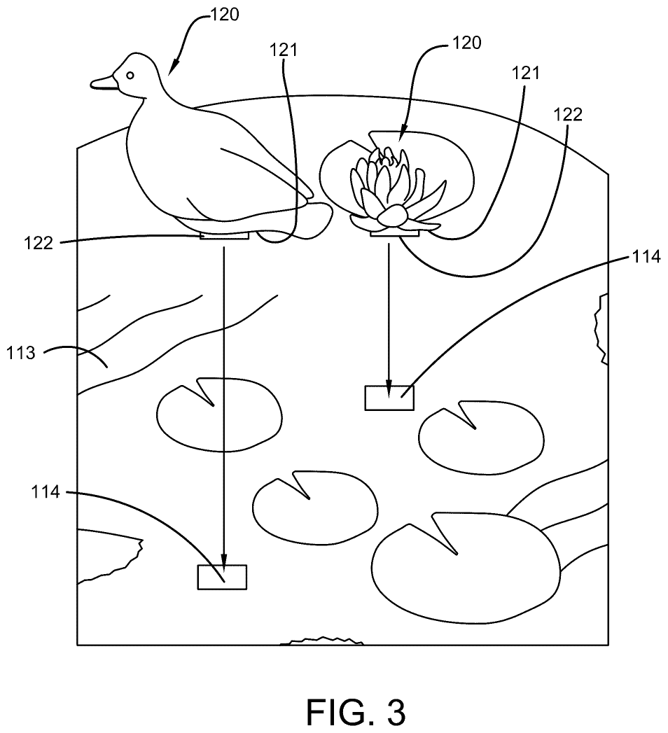

FIG. 4 illustrates a flowchart of a method of using one potential embodiment of a simulative pond device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a hunting equipment device that eliminates the requirement of naturally occurring water to attract water-based wildlife. More specifically, there exists a long-felt need in the art of hunting for a simulative pond device that can be used to replicate naturally occurring bodies of water to attract water-based wildlife.

The present invention, in one exemplary embodiment, is comprised of a base with a bottom surface, a top surface, at least one indicia, and at least one grommet. The device is designed such that the top surface of the base can receive at least one decorative element to simulate a pond and animals. The base is preferably any shape that resembles a body of water, wherein the top surface has at least one indicia that may include but is not limited to patterns, textures, and shapes that replicate water, naturally occurring foliage, and other natural water scenery of the like. In one embodiment, the base is comprised of at least one grommet that allows at least one fastener to be driven through the grommet and into a ground surface to secure the base to said surface during use.

The device is also comprised of at least one decorative element. The decorative element is comprised of a bottom surface comprised of at least one fastener. The fastener of the element removably attaches to at least one fastener of the top surface to allow the element to be repositioned or moved as needed. The decorative element may resemble plants and wildlife including but not limited to lily pads, grass, weeds, ducks, geese, swans, mallards, and other such animals and wildlife found near any type of water. As a result, the device is able to replicate a naturally occurring habitat with water-based wildlife.

The present invention is also comprised of a method of using the device. First, a device is provided comprised of a base having a top surface comprised of at least one fastener and a decorative element comprised of at least one fastener located on a bottom surface of the decorative element. Then, the base can be secured to a ground surface by driving at least one fastener through at least one grommet of the base and into the ground surface. Next, at least one decorative element can be attached to the top surface of the base by attaching the fastener of the decorative element to the fastener of the top surface. Then, a user can position themselves near the device such that the device serves as a decoy to attract game birds while hunting for the same.

Accordingly, the simulative pond device of the present invention is particularly advantageous as it provides a device that eliminates the need for water while emulating the habitat of water-based game. More specifically, the simulative pond device can be used as an alternative for hunters that are physically constrained or have no access to water. Furthermore, the device is lightweight and can be universally used in any hunting environment. In this manner, the simulative pond device overcomes the limitations of existing hunting practices and devices known in the art.

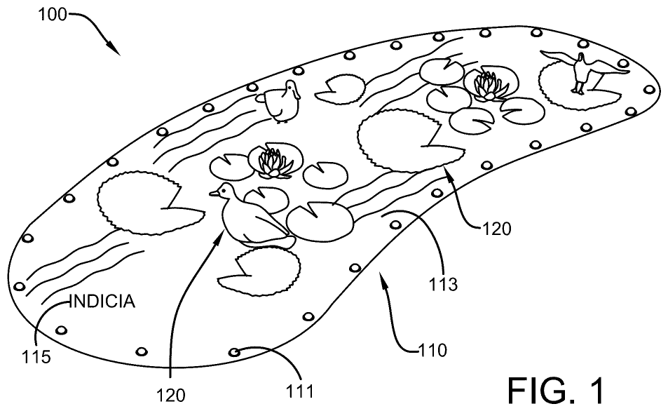

Referring initially to the drawings, FIG. 1 illustrates a perspective view of one potential embodiment of a simulative pond device 100 of the present invention in accordance with the disclosed architecture. The device 100 is comprised of a base 110. The base 110 has a bottom surface 121, top surface 113, at least one indicia 115, and at least one grommet 111. The device 100 is designed such that the top surface 113 of the base 110 can receive at least one decorative element 120 to simulate a pond and animals.

The base 110 is preferably made from a lightweight material including but not limited to polyester, canvas, nylon polyethylene, and polypropylene. The base 110 material is preferably foldable for easy storage and transport. The base 110 is preferably kidney shaped (or any shape that resembles a body of water) but may be any shape in different embodiments. The top surface 113 has at least one indicia 115 that may include but is not limited to patterns, textures, and shapes that replicate water, naturally occurring foliage, and other natural water scenery of the like. In one embodiment, the top surface 113 may be shiny or reflective to further simulate the appearance of a body of water.

In one embodiment, the base 110 is comprised of at least one grommet 111. The grommet allows at least one fastener 112, such as but not limited to a ground stake, to be driven through the grommet and into a ground surface to secure the base 110 to said surface during use.

The device 100 is also comprised of at least one decorative element 120 preferably made from durable plastic or rubber material. The decorative element 120 is comprised of a bottom surface 121 comprised of at least one fastener 122. The fastener 122 may be any type such as but not limited to magnets, hook and loop, snap button, etc. The fastener 122 of the element 120 removably attaches to at least one fastener 114 of the top surface 113 to allow the element 120 to be repositioned or moved as needed on the top surface 113. The fastener 114 of the top surface 113 may be any reciprocating fastener type to the fastener 122 of the element 120. In one embodiment, the top surface 113 may be made from a magnetic material to receive a magnetic fastener 122.

The decorative element 120 may resemble plants and wildlife including but not limited to lily pads, grass, weeds, ducks, geese, swans, mallards and other such animals and wildlife found near any type of water. As a result, the device 100 is able to replicate a naturally occurring habitat with water-based wildlife, as seen in FIG. 1.

In one embodiment, the base 110 may be shaped and have the appearance of any location, structure, naturally occurring area, etc. that may relate to a decorative occasion such as but not limited to a holiday. In this embodiment, the decorative element 120 may also resemble any character, animal, shape, object, etc. that may or may not relate to a common theme shared with the base 110 such as but not limited to a holiday, a birthday, engagement, a wedding, a graduation, etc. In this manner, the device 100 can also be used as an outdoor decoration.

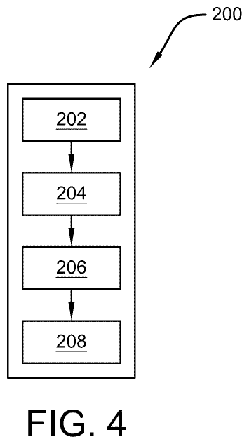

The present invention is also comprised of a method of using 200 the device 100 as seen in FIG. 4. First, a device 100 is provided comprised of a base 110 having a top surface 113 comprised of at least one fastener 114 and a decorative element 120 comprised of at least one fastener 122 located on a bottom surface 121 of the decorative element 120 [Step 202]. Then, the base 110 can be secured to a ground surface by driving at least one fastener 112 through at least one grommet 111 of the base 110 and into the ground surface [Step 204]. Next, at least one decorative element 120 can be attached to the top surface 113 of the base 110 by attaching the fastener 122 of the decorative element 120 to the fastener 114 of the top surface 113 [Step 206]. Then, a user can position themselves near the device 100 such that the device 100 serves as a decoy to attract game birds while hunting for the same [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “simulative pond device” and “device” are interchangeable and refer to the simulative pond device 100 of the present invention.

Notwithstanding the forgoing, the simulative pond device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the simulative pond device 100 as shown in the FIGS. are for illustrative purposes only, and that many other sizes and shapes of the simulative pond device 100 are well within the scope of the present disclosure. Although the dimensions of the simulative pond device 100 are important design parameters for user convenience, the simulative pond device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A simulative pond device comprising:
a base comprised of a top surface; and
a decorative element comprised of a bottom surface comprised of a fastener.

2. The simulative pond device of claim 1, wherein the top surface is comprised of an indicia.

3. The simulative pond device of claim 2, wherein the indicia is comprised of a pattern, a texture, or a shape that replicates a water, a naturally occurring foliage, or a natural water scenery.

4. The simulative pond device of claim 1, wherein the base is comprised of a polyester, a canvas, a nylon polyethylene, or a polypropylene.

5. The simulative pond device of claim 1, wherein the top surface is reflective or shiny.

6. The simulative pond device of claim 1, wherein the top surface is magnetic.

7. The simulative pond device of claim 1, wherein the fastener is comprised of a magnet.

8. The simulative pond device of claim 1, wherein the fastener is comprised of a hook and loop fastener or a snap button.

9. A simulative pond device comprising:
a first fastener;
a base comprised of a top surface comprised of a second fastener, and a grommet; and
a decorative element comprised of a bottom surface comprised of a third fastener.

10. The simulative pond device of claim 9, wherein the first fastener is comprised of a ground stake.

11. The simulative pond device of claim 9, wherein the top surface is comprised of an indicia.

12. The simulative pond device of claim 11, wherein the indicia is comprised of a pattern, a texture, or a shape that replicates a water, a naturally occurring foliage, or a natural water scenery.

13. The simulative pond device of claim 9, wherein the base is comprised of a polyester, a canvas, a nylon polyethylene, or a polypropylene.

14. The simulative pond device of claim 9, wherein the top surface is reflective or shiny.

15. The simulative pond device of claim 9, wherein the second fastener is comprised of a magnet.

16. The simulative pond device of claim 9, wherein the second fastener is comprised of a hook and loop fastener or a snap button.

17. The simulative pond device of claim 9, wherein the fastener is comprised of a magnet.

18. The simulative pond device of claim 9, wherein the fastener is comprised of a hook and loop fastener or a snap button.

19. A method of using a simulative pond device, the method comprising the following steps:
providing a simulative pond device comprised of a base comprised of a top surface comprised of a first fastener and a decorative element comprised of a second fastening;
securing the base to a ground surface;
attaching the decorative element to the first fastener via the second fastener; and
using the simulative pond device as a hunting decoy while hunting for a game bird.

20. The method of using a simulative pond device of claim 19, wherein the top surface is comprised of a reflective or a shiny surface.
